(19) United States
(12) Patent Application Publication
(10) Pub. No.: US 2015/0332309 A1
(43) Pub. Date: Nov. 19, 2015

(54) ADVERTISEMENT SCORING SYSTEM AND METHOD

(71) Applicant: ISPOT.TV, INC., Bellevue, WA (US)

(72) Inventors: Sean MULLER, Bellevue, WA (US); Ewan GODLEY, Renton, WA (US); Scott HAPPELL, Redmond, WA (US); Greg HAVENER, Woodinville, WA (US); Adam YOUNGERS, Bellevue, WA (US)

(73) Assignee: ISPOT.TV, INC., Bellevue, WA (US)

(21) Appl. No.: 14/276,920

(22) Filed: May 13, 2014

(51) Int. Cl. G06Q 30/02; G06F 17/30

(52) U.S. Cl. CPC G06Q 30/0242; G06F 17/30312; G06F 17/30864

(57) ABSTRACT

A computer system and set of routines which determine a score for an advertisement.

### FIELD

The present disclosure relates to the field of assigning an effectiveness score to an advertisement.

### BACKGROUND

Television ratings are antiquated, based on small sample sets, are slow to provide reports, and lack data relating to the use of mobile devices to watch television or the use of mobile devices while watching television. Nonetheless, television ratings are still used to determine the rates which advertisers pay for placement of advertisements.

Advertisements in webpages are closely tracked, with systems that track and record the number of impressions and clicks on the advertisements, the conversion of clicks into further actions (such as sales of products or clicks on other links), and information regarding users (generally users of the computer which is rendering the webpage).

A scoring system for television advertisements is needed to provide an effectiveness score for advertisements, which takes into account measurements relating to searches for the advertisement, social network communications relating to the advertisement, and the number of times the advertisement was played or shared online, all in relation to the amount spent to air the advertisement on television.

### BRIEF DESCRIPTION OF THE DRAWINGS

FIG. 1 illustrates a simplified advertisement score diagram in which an iSpot Server, an End User Device, a Broadcaster, an Online Video Server, an Estimated Spend Server, a Social Media Server, and a Search Server are connected to a Computer Network and a Broadcast Network.

FIG. 2 is a functional block diagram of an exemplary iSpot Server computing device and some data structures and/or components thereof.

FIG. 3 is a functional block diagram of the iSpot Datastore.

FIG. 4 illustrates a Network Monitor Routine.

FIG. 5 illustrates a Spend Estimation Routine.

FIG. 6 illustrates an Ad Score Routine.

FIG. 7 illustrates a Search Score Routine.

FIG. 8 illustrates a Social Score Routine.

FIG. 9 illustrates a Video Score Routine.

FIG. 10 illustrates a Score Estimation Routine.

### DETAILED DESCRIPTION

It is intended that the terminology used in the description presented below be interpreted in its broadest reasonable manner, even though it is being used in conjunction with a detailed description of certain examples of the technology. Although certain terms may be emphasized below, any terminology intended to be interpreted in any restricted manner will be overtly and specifically defined as such in this Detailed Description section.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the term “connected,” “coupled,” or any variant thereof means any connection or coupling, either direct or indirect between two or more elements; the coupling of connections between the elements can be physical, logical, or a combination thereof. Additionally, the words, “herein,” “above,” “below,” and words of similar import, when used in this application, shall refer to this application as a whole and not to particular portions of this application. When the context permits, words using the singular may also include the plural while words using the plural may also include the singular. The word “or,” in reference to a list of two or more items, covers all of the following interpretations of the word: any of the items in the list, all of the items in the list, and any combination of one or more of the items in the list. References are made herein to routines and subroutines; generally, it should be understood that a routine is a software program executed by computer hardware and that a subroutine is a software program executed within another routine. However, routines discussed herein may be executed within another routine and subroutines may be executed independently (routines may be subroutines and vice versa).

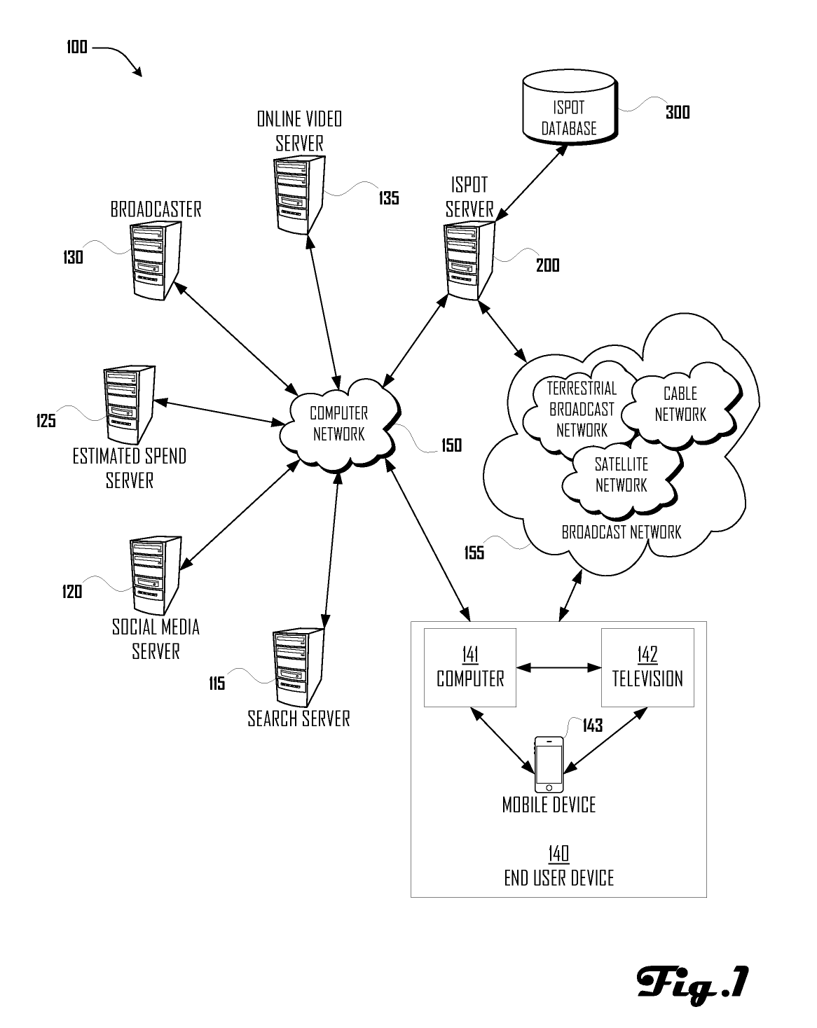

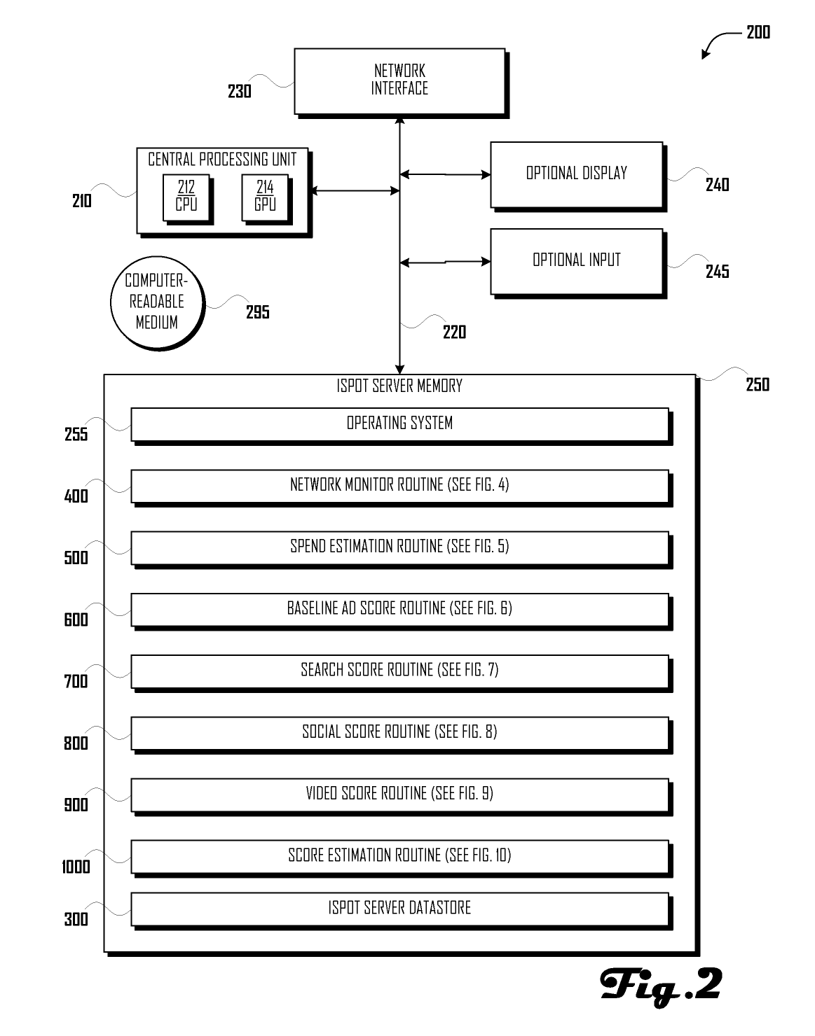

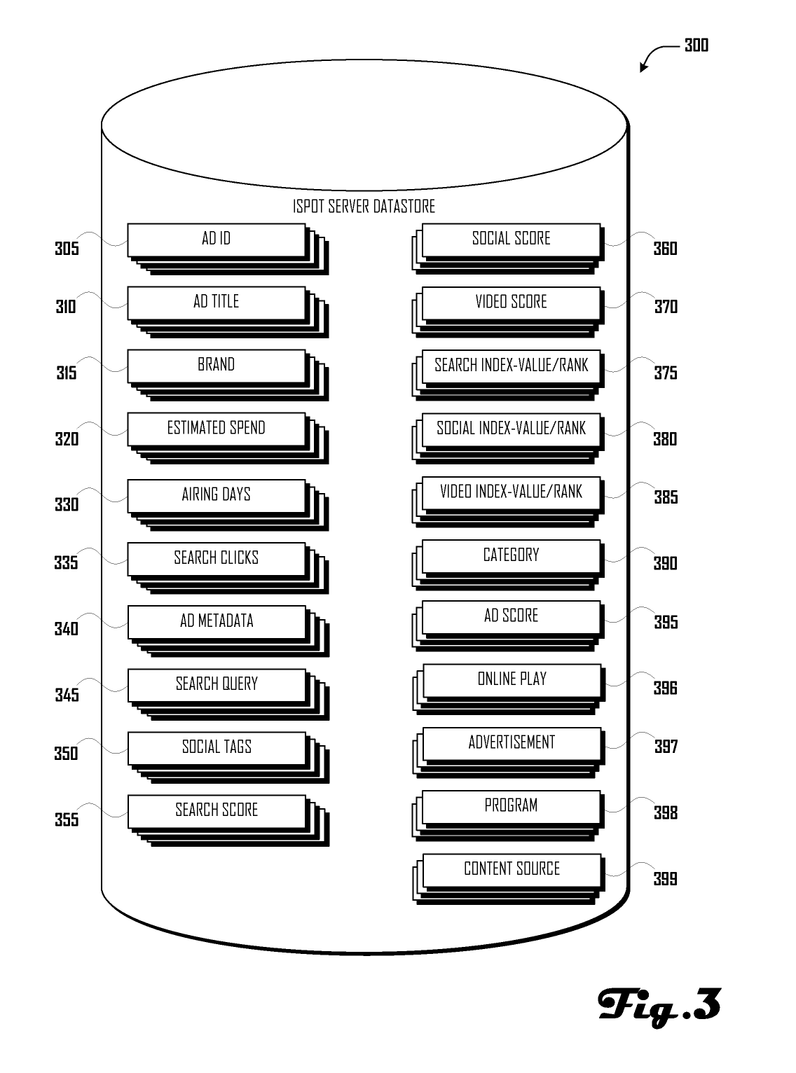

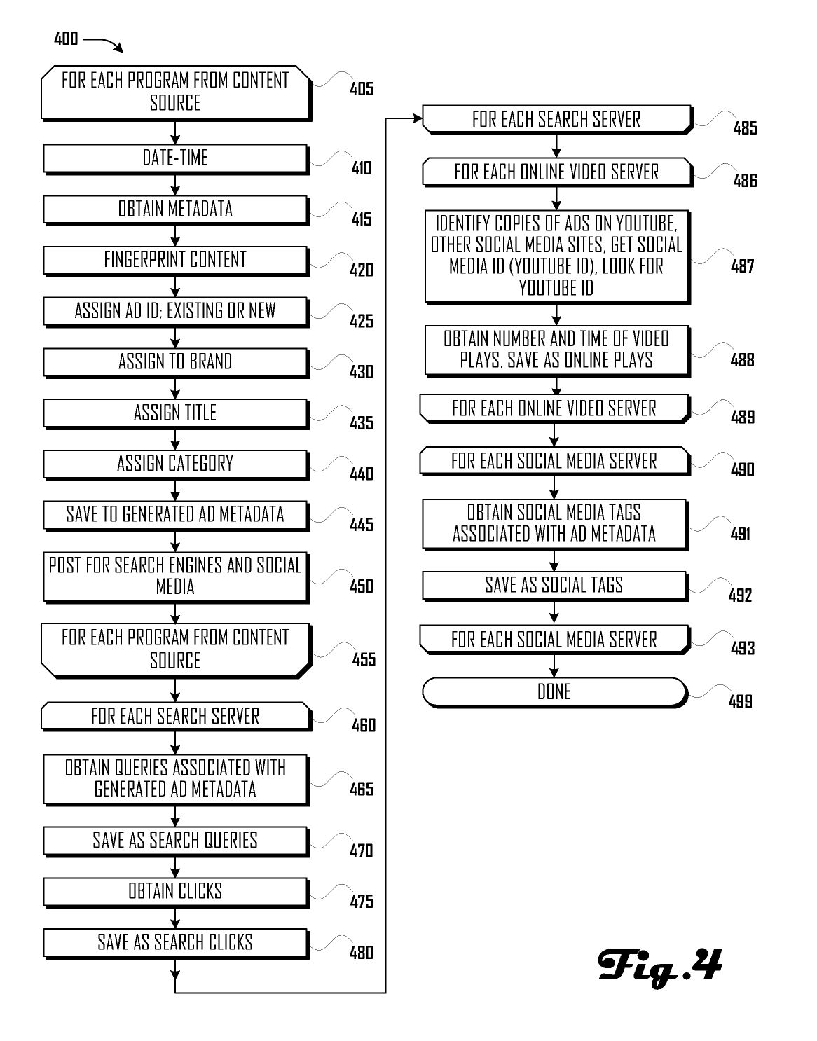

FIG. 1 illustrates a simplified advertisement scoring diagram in which iSpot Server 200, iSpot Database 300, End User Device 140, Broadcaster 130, Online Video Server 135, Estimated Spend Server 125, Social Media Server 120, and Search Server 115 are connected to Computer Network 150 and Broadcast Network 155. iSpot Server 200 and iSpot Database 300 are general purpose computers, described further below in relation to FIGS. 2 and 3, which computers execute a set of routines, described further below in relation to FIGS. 4 through 10. End User Device 140, Broadcaster 130, Online Video Server 135, Estimated Spend Server 125, Social Media Server 120, and Search Server 115 are also computers executing routines particular to the domain of each.

Briefly, End User Device 140 represents different computers which members of the public use for purposes such as watching television (such as via Television 142), accessing websites, searching on Search Server 115, sending email, and communicating on social networks (such as via Computer 141 and Mobile Device 143). All references herein to End User Device 140 should be understood to be performed by any of Computer 141, Television 142, and Mobile Device 143.

Search Server 115 represents search engines, such as those provided by Google, Bing, Yahoo, and the like. Generally, Search Server 115 searches for content on the Internet in both “wild” searches, which follow links on webpages, as well as directed searches which follow information obtained by Search Server 115. Information obtained by Search Server 115 includes information submitted to Search Server 115 by content sources, generally with the intention that Search Server 115 will index the information and make it available in response to search queries submitted by the general public, such as through End User Device 140.

Social Media Server 120 represents social media services which enable communication among or with the general public and social groups therein. Types of social media services (and examples) include collaborative projects (such as Wikipedia), blogs and microblogs (such as Twitter), news networking sites (such as Digg and Leakernet), content communities (such as YouTube and DailyMotion), social networking sites (such as Facebook), and online game-worlds (such as World of Warcraft).

Broadcaster 130 is a broadcaster of television or video programming, generally on Broadcast Network 155, and generally of live or pre-recorded programming. Programming is generally broadcast on “channels”. Broadcast Network 155 represents terrestrial broadcast television stations, cable systems, and satellite systems, and networks thereof.

Online Video Server 135 represents an online provider of video, such as YouTube, Vimeo, and the like, which generally allow members of the public, including users of End User Device 140 and Broadcaster 130, to upload videos, metadata, and other content to Online Video Server 135, which content Online Video Server 135 makes available to the public and groups within the public. Online Video Server 135 may be considered to be a type of social media service which may also be provided by Social Media Server 120.

Estimated Spend Server 125 is operated by a party who provides information relating to the amount spent to produce and/or distribute programming and advertisements on Broadcaster 130.

As discussed further herein, iSpot Server 200 executes Network Monitor Routine 400 to record instances of advertisements and metadata associated with advertisements, which are generally obtained via Broadcast Network 155 and are part of live or pre-recorded linear programming. Among other metadata which are assigned to advertisements by the Network Monitor Routine 400, Network Monitor Routine 400 assigns Ad ID 305 to each different instance of an advertisement. References herein to “Ad ID 305” refer to advertisements which have been recorded or detected by Network Monitor Routine 400 and the identifier, thereof, used by the iSpot Server 200 in various routines executed by the iSpot Server 200. Network Monitor Routine 400 and other metadata assigned to or associated with advertisements and Ad ID 305 are discussed further below in relation to FIG. 4.

Network Monitor Routine 400 also detects copies of advertisements on Online Video Server 135 (such as YouTube) and other video repositories available via Computer Network 150 and records the number of times such copies are played from such repositories, as well as the number of times the advertisements are searched for on search engines, such as on Search Server 115, and the number of times search results are served to an End User Device 140. Network Monitor Routine 400 also detects instances of social media tags associated with previously detected advertisements.

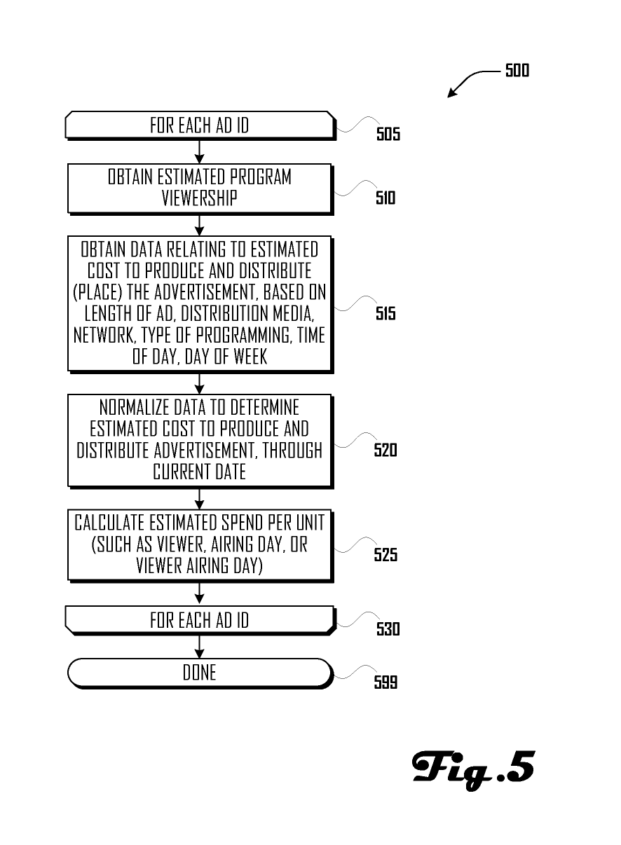

The iSpot Server 200 also executes Spend Estimation Routine 500 to calculate an estimated amount of spending advertisements. Spend Estimation Routine 500 is discussed further below in relation to FIG. 5.

The iSpot Server 200 also executes Ad Score Routine 600 to calculate a score for advertisements, Ad Score 395. The Ad Score 395 is calculated based on, for example, Search Score 355, Social Score 360, and Video Score 370. Ad Score Routine 600 is discussed further below in relation to FIG. 5.

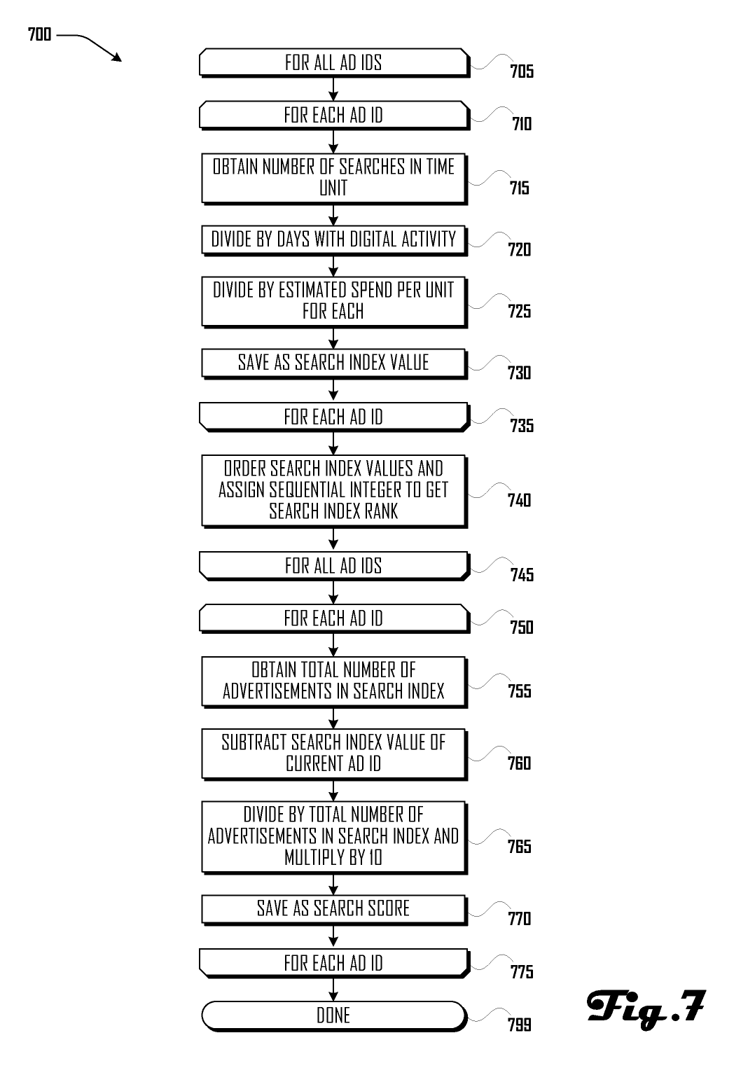

The iSpot Server 200 also executes Search Score Routine 700 to calculate a score relating to, among other factors, how often advertisements are searched for by individuals, Search Score 355. Search Score Routine 700 is discussed further below in relation to FIG. 7.

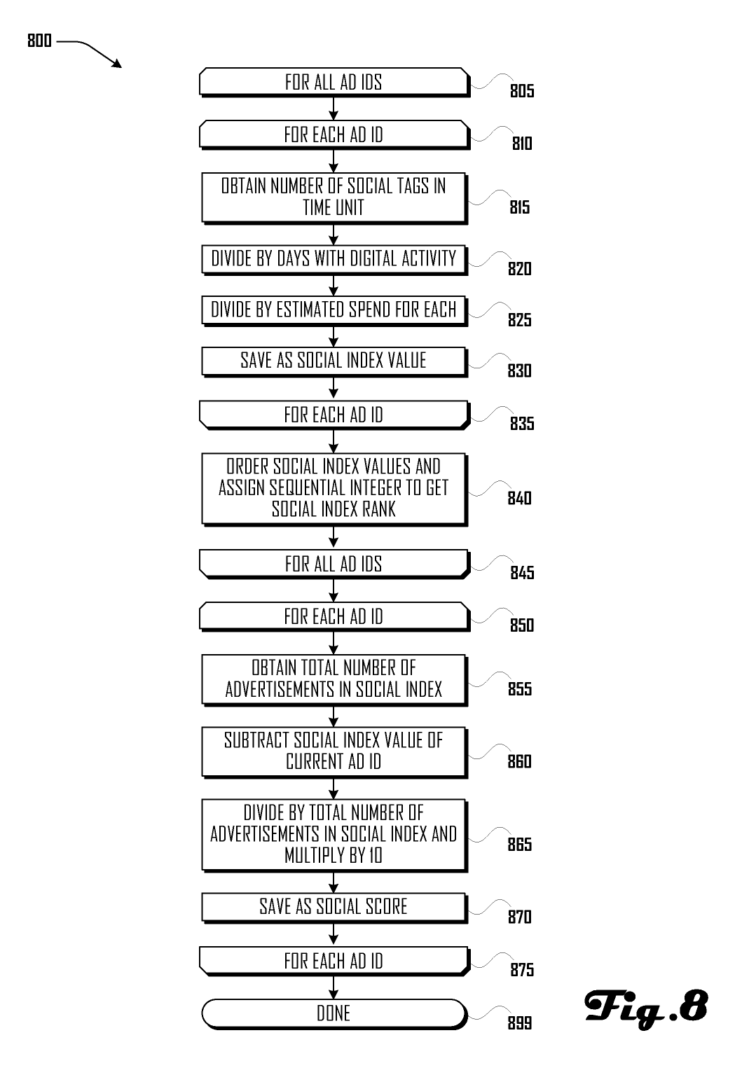

The iSpot Server 200 also executes Social Score Routine 800 to calculate a score relating to, among other factors, how often advertisements are shared or appear in communications on social media, Social Score 360. Social Score Routine 800 is discussed further below in relation to FIG. 8.

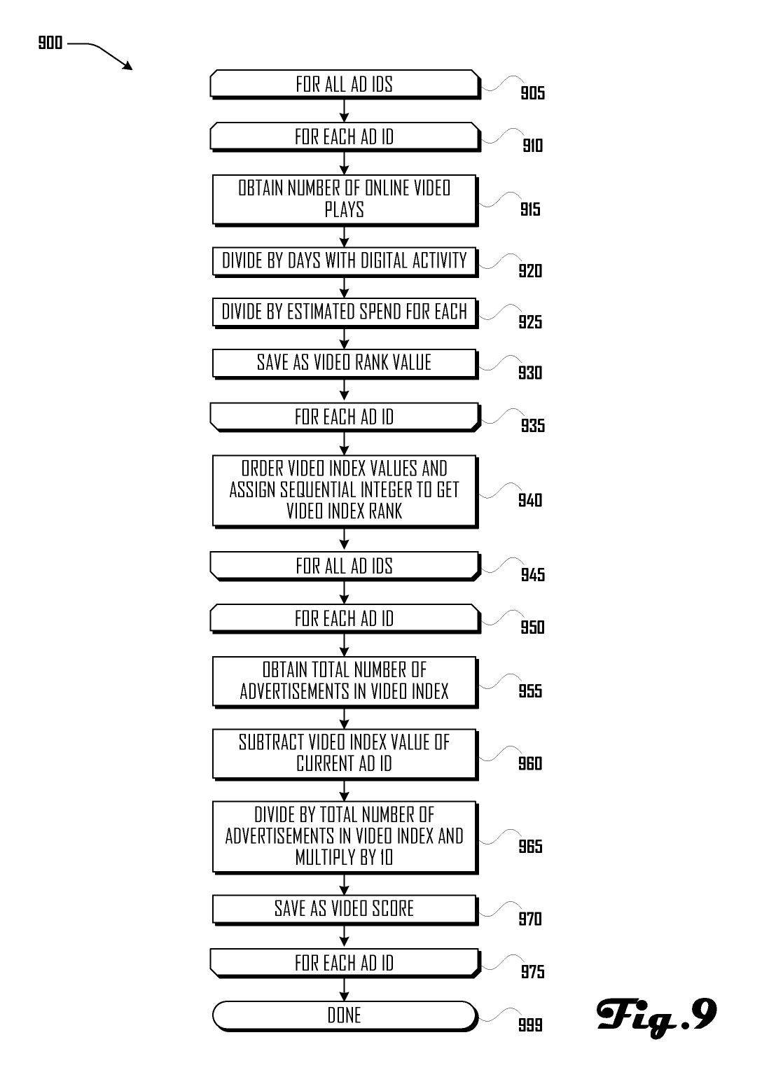

The iSpot Server 200 also executes Video Score Routine 900 to calculate a score relating to, among other factors, how often advertisements are played online, Video Score 370. Video Score Routine 900 is discussed further below in relation to FIG. 9.

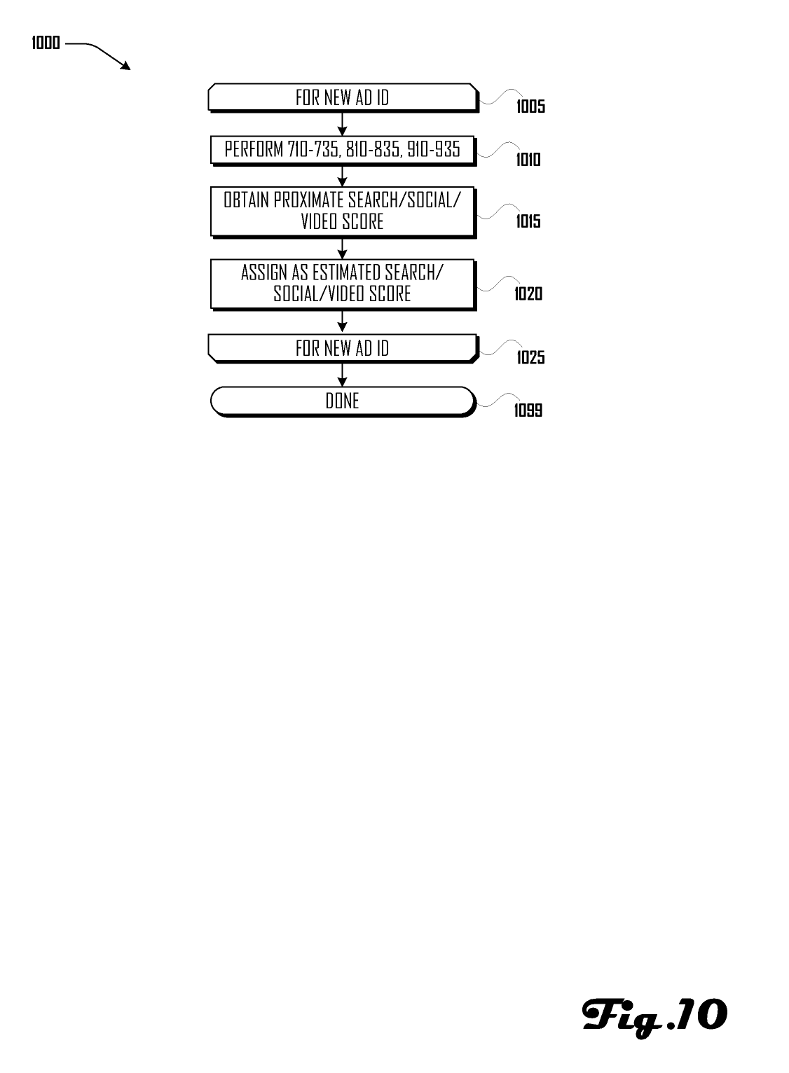

The iSpot Server 200 also executes Score Estimation Routine 1000 to estimate an Ad Score 395 without performing the full Ad Score Routine 600. Score Estimation Routine 1000 is discussed further below in relation to FIG. 10.

The iSpot Server 200 and iSpot Database 300 are illustrated and discussed further in relation to FIGS. 2 and 3.

The computing devices illustrated in FIG. 1 are illustrated as connecting to Computer Network 150 and/or Broadcast Network 155. Connection to the Computer Network 150, Broadcast Network 155, or direct connection between computing devices may require that the computers execute software routines which enable, for example, the seven layers of the Open System Interconnection (OSI) model of computer networking or equivalent in a wireless phone or wireless data network. The Computer Network 150 and Broadcast Network 155 comprise computers, network connections among the computers, and software routines to enable communication between the computers over network connections.

Computer Network 150 may comprise, for example, an Ethernet network and/or the Internet. Broadcast network 155 may comprise, for example, digital terrestrial television networks, cable television networks, satellite television networks and the like. This paper discusses television; it should be understood that radio (audio) may be accessed and processed in an equivalent manner. Communication among the various computers and routines may utilize various data transmission standards and protocols such as, for example, the application protocol HTTP and standards used in digital television broadcasting, such as Digital Video Broadcasting (“DVB”) standards, Advanced Television Systems Committee (“ATSC”) standards, Integrated Services Digital Broadcasting (“ISDB”), Digital Terrestrial Multimedia Broadcast (“DTMB”) standards, and Digital Multimedia Broadcasting (“DMB”) standards. Transmitted data may encode documents, files, and data in various formats such as, for example, HTML, XML, flat files, and JSON, all of which may incorporate media files such as HEVC, H.262, H.264, AVS, MP2, MP3 AC-3, AAC.

This paper may discuss components as connecting to the iSpot Server 200 or to the iSpot Server Datastore 300; it should be understood that such connections may be to, through, or via the other of the two components (for example, a statement that a computing device connects with or sends data to the iSpot Server 200 should be understood as saying that the computing device may connect with or send data to the iSpot Server Datastore 300). References herein to “database” should be understood as equivalent to “datastore.” The other computers illustrated in FIG. 1 may comprise a datastore.

Although illustrated in these Figures as components integrated in one physical unit, the computers, servers and databases may be provided by common (or separate) physical hardware and common (or separate) logic processors and memory components. The computer components illustrated in FIG. 1 represent what may be multiple instances of computing devices which may execute distributed software routines. The software routines and data groups used by the software routines may be stored and/or executed remotely relative to any of the computers through, for example, application virtualization.

The iSpot Server 200 illustrated in FIG. 1 is further illustrated in FIGS. 2 and 3 as comprising data groups for software routines and data groups used by routines. In addition to the data groups explicitly illustrated in FIGS. 2 and 3 and discussed herein, additional data groups may also be present in and/or executed by this device, such as routines for databases, webservers, and web browsers, and routines to enable communication with other computers. The data groups used by routines may be represented by a cell in a column or a value separated from other values in a defined structure in a digital document or file. Though referred to herein as individual records or entries, the records may comprise more than one database entry. The database entries may be, represent, or encode numbers, numerical operators, binary values, logical values, text, string operators, joins, conditional logic, tests, and similar. Login credentials and local instances of user or device profiles may be stored in or be accessible to devices and routines executed thereby. Such user or device profiles may be utilized to provide secure communication between the computers.

FIG. 2 is a functional block diagram of an exemplary iSpot Server 200 computing device and some data structures and/or components thereof. The computing device 200 comprises at least one Processing Unit 210, iSpot Server Memory 250, and an optional Display 240, all interconnected along with the Network Interface 230 via a Bus 220. The Network Interface 230 may be utilized to form connections with the Computer Network 150 and Broadcast Network 155 and to send and receive radio frequency (“RF”) and other wireless and wireline signals.

The iSpot Server Memory 250 generally comprises a random access memory (“RAM”), a read only memory (“ROM”), and a permanent mass storage device, such as a disk drive or SDRAM (synchronous dynamic random-access memory). The iSpot Server Memory 250 stores program code or data groups for software routines, such as, for example, Network Monitor Routine 400, Spend Estimation Routine 500, Ad Score Routine 600, Search Score Routine 700, Social Score Routine 800, Video Score Routine 900, Score Estimation Routine 1000, as well as browser, webserver, email client and server routines, camera, other client applications, and database applications. In addition, the iSpot Server Memory 250 also stores Operating System 255 and iSpot Server Datastore 300. Webserver and browser routines provide an example of interfaces for interacting among the computing devices illustrated in FIG. 1, all which may serve and respond to data and information in the form of webpages and html documents or files or the like. The browsers and webservers are meant to illustrate user- and machine-interfaces and enabling routines generally, and may be replaced by equivalent routines for serving and rendering information to and in a user or machine interface in a computing device (whether in a web browser or in, for example, a mobile device application).

These software components may be loaded from a non-transient Computer Readable Storage Medium 295 into iSpot Server Memory 250 of the computing device using a drive mechanism (not shown) associated with a non-transient Computer Readable Storage Medium 295, such as a floppy disc, tape, DVD/CD-ROM drive, memory card, or other like storage medium. In some embodiments, software components may also or instead be loaded via a mechanism other than a drive mechanism and Computer Readable Storage Medium 295 (e.g., via Network Interface 230).

The computing device 200 may also comprise hardware supported input modalities, Input 245, such as, for example, a touchscreen, a keyboard, a mouse, a trackball, a stylus, a microphone, accelerometer(s), compass(es), RF receivers (to the extent not part of the Network Interface 230), and a camera, all in conjunction with corresponding routines.

The iSpot Server 200 may also comprise or communicate via Bus 220 with iSpot Server Datastore 300, illustrated further in FIG. 3. In various embodiments, Bus 220 may comprise a storage area network (“SAN”), a high speed serial bus, and/or via other suitable communication technology. In some embodiments, iSpot Server 200 may communicate with the iSpot Server Datastore 300 via Network Interface 230. The iSpot Server 200 may, in some embodiments, include many more components than those shown in this Figure. However, it is not necessary that all of these (or other) generally conventional components be shown in order to disclose an illustrative embodiment.

FIG. 3 is a functional block diagram of the iSpot Server Datastore 300 illustrated in FIG. 2. The components of the iSpot Server Datastore 300 are data groups used by routines and are discussed further herein in the discussion of other Figures. The data groups used by routines illustrated in FIG. 3 may be represented by a cell in a column or a value separated from other values in a defined structure in a digital document or file. In addition to the data groups used by routines illustrated in FIG. 3, login credentials and local instances of customer and user profiles may be stored in or be accessible to all of the computing devices illustrated in FIG. 1 via iSpot Server Datastore 300 or the like.

FIG. 4 illustrates Network Monitor Routine 400. Blocks 405 to 455 iterate for each program from an advertisement-including content source, also referred to as a “content source,” which iSpot Server 200 and Network Monitor Routine 400 can receive via, for example, television, cable, and satellite broadcast channels on Broadcast Network 155. Programs may be associated with records such as Program 398 record, which may record, for example, a program name, producer, length, date-time, language, geographic location, and the like. Content sources may be associated with records such as Content Source 399 record, which may record, for example, channel and network names, geographic location, and the like. Content Sources 399 may transmit Programs 398 on or according to channels, lineups, schedules and the like.

At block 410, the Network Monitor Routine 400 obtains a date-time from the Content Source 399 and/or a separate source. This may be saved as, for example, an Airing Days 330 record. At block 415, the Network Monitor Routine 400 obtains other metadata included in and/or associated with the Program 398, such as titles, subtitles, captions (including EIA-608), copyright information, and the like.

At block 420, the Network Monitor Routine 400 may prepare or obtain a digital fingerprint of the content, such as of Program 398. The fingerprint may be in relation to a single image frame, multiple image frames, and/or the audio of the content, and may contain a trademark, a slogan, text, a code or other data associated with a source of a good or service, referred to herein as Brand 315. The fingerprint may be a hash. The Program 398 includes advertisements. The fingerprint may be recorded in, for example, an Ad Metadata 340 record.

At block 425, when Network Monitor Routine 400 detects an advertisement, such as according to a fingerprint, a change in encoding, a change in a file or stream name, and/or according to metadata included in and/or associated with the Program 398, Network Monitor Routine 400 assigns an Ad ID 305 to the detected advertisement. The Ad ID 305 may be an existing Ad ID 305, if the advertisement is identified to be the same as a previously identified advertisement, or a new Ad ID 305 may be assigned, if not. The advertisement may be recorded as Advertisement 397 record.

At block 430, if Advertisement 397 is not already associated with these records or to confirm these records, Network Monitor Routine 400 assigns or matches Advertisement 397 to Brand 315. This step may be aided by metadata collected at block 415 and/or the fingerprint of block 420. This step may be performed programmatically and/or with human assistance. At block 435, a title, such as Ad Title 310, is associated with or assigned to Advertisement 397. The Ad Title 310 may be provided by Program 398 such as from metadata, with search results, and/or may be provided by or with human assistance.

At block 440, a category is associated with Ad ID 305 for the Advertisement 397 and may be recorded as Category 390. The Category 390 may be drawn from metadata in or associated with the Advertisement 397, from a third party, and/or may be provided by or with human assistance. The Category 390 may be a category within a hierarchical schema. The Category 390 may identify a type of advertisement, a type of good or service advertised, or a type of programming in which the advertisement appeared.

At block 445, the results of the foregoing may be saved to, for example, Ad Metadata 340 record; certain of the metadata for advertisements, such as Ad Title 310, are illustrated for the sake of convenience as being recorded in a separate record though should be considered as part of Ad Metadata 340 record.

At block 450, the Ad Metadata 340 and, optionally, a link to the recorded Advertisement 397 on the iSpot Server 200 is posted or made available for indexing by search engines, such as by Search Server 115, and/or is posted or made available to an online video service, as may be provided by Online Video Server 135, and/or to a social media service, as may be provided by Social Media Server 120.

Block 455 may return to block 405 to iterate over the next Program 398 in the same or another Content Source 399.

While or after blocks 405 to 455 are iterating, blocks 460 to 485 may iterate for each Search Server 115. Communication between the Network Monitor Routine 400 and the Search Server 115 may be facilitated by, for example, an API provided by Search Server 115.

At block 465, queries made by users at End User Device 140 which are associated with Ad Metadata 340 may be obtained from Search Server 115. These may be queries and responses to queries at Search Server 115 as a result of Ad Metadata 340 and other information posted at block 450 and queries input into Search Server 115 by end users. Responses to the queries by the Search Server 115 may comprise links to the Advertisement 397 at the iSpot Server 200. At block 470, the obtained queries, date-time, identifier of Search Server 115, and other information and data may be saved as Search Query 345.

At block 475, clicks by users at End User Device 140 on query results may be obtained by the Network Monitor Routine 500. These may be obtained directly from End User Device 140 as part of the clicks (which may be detected at the iSpot Server 200) and/or these may be obtained from Search Server 115, such as through utilization of a search server API. These may be clicks on queries at Search Server 115 as a result of Ad Metadata 340 and other information posted at block 450. These clicks may comprise clicks on links to the Advertisement 397 at the iSpot Server 200. At block 480, the results of block 475 may be saved as Search Clicks 335.

Block 485 returns to block 460 to iterate over the next Search Server 115, if any.

While or after blocks 405 to 455 and blocks 460 to 485 are iterating, blocks 486 to 489 may iterate for each Online Video Server 135.

At block 487, Network Monitor Routine 400 contacts Online Video Server 135, such as YouTube, and identifies copies of Advertisements 397 which have been posted to the online video service. Identification of copies may be according to the fingerprint prepared at block 420 and/or according to Ad Metadata 340 saved at block 445. At block 488, Network Monitor Routine 400 obtains an identifier used by the Online Video Server 135 in relation to the copy of the Advertisement 397 at Online Video Server 135. This identifier may be stored by the Network Monitor Routine 400 in, for example, Ad Metadata 340 records.

At block 488, Network Monitor Routine 400 contacts Online Video Server 135 and, using the identifier used by the Online Video Server 135 in relation to the copy of the Advertisement 397, obtains the number of times the copy of Advertisement 397 at Online Video Server 135 was played by Online Video Server 135 as well as the date-time of such plays. This information may be saved in, for example, Online Play 396 records. The number of times the Advertisement 397 was played by Online Video Server 135 as well as the date-time of such plays is determined by end users who contact Online Video Server 135 and who search for, browse to, or otherwise access the advertisement at Online Video Server 135. Online Video Server 135 typically records data such as the number of searches, the number of times the advertisement appears in search results or browse accesses (instances when someone browses through a hierarchy), and the number of times the advertisement was then played by a user. At least the number of times the copy of Advertisement 397 was played by Online Video Server 135 as well as the date-time of such plays is obtained at block 488. Network Monitor Routine 400 may also obtain the number of times the advertisement appears in search results and the search queries which resulted in such search results.

Block 489 may return to block 486 to iterate over the next Online Video Server 135, if any.

While or after blocks 405 to 455, blocks 460 to 485, and blocks 486 to 489 are iterating, blocks 490 to 493 may iterate for each Social Media Server 115. The Social Media Server 115 may provide social media services which enable one-to-one and one-to-many communication, often with the general public or among designated or selected people or groups of people; examples include Facebook, Twitter, YouTube, Google+, Pinterest, and the like. Users of the social media services may post, for example, Tweets, Likes, Shares, comments, links, and the like, together referred to herein as social tags, records relating to which may be stored as Social Tags 350.

At block 491, Network Monitor Routine 400 may contact Social Media Server 120 and obtain social tags associated with Advertisements 397 and Ad IDs 305. These tags may be obtained by searching Social Media Server 120 for Ad Metadata 340. At block 492, Network Monitor Routine 400 may save these as Social Tags 350, in association with Ad ID 305.

Block 493 may return to block 490 to iterate over the next Social Media Server 120, if any.

At block 499, the Network Monitor Routine 500 may return to iterate over its beginning, at block 405, or may conclude.

FIG. 5 illustrates a Spend Estimation Routine 500, in which an amount spent on an advertisement is estimated. Blocks 505 to 530 iterate for each Ad ID 305.

At block 510, estimated program viewership for the Ad ID 305 may be obtained by the Spend Estimation Routine 500. The program viewership may be relative to the Advertisement 397 associated with the Ad ID 305, relative to a Program 398 in which the Advertisement 397 associated with the Ad ID 305 appeared, a Program 398 for a geographic area, a channel, a distribution network, a unit of time, an incidence of transmission, and according to other parameters as may be used in relation to describing program viewership. These values may need to be normalized relative to the units used by the Spend Estimation Routine 500. This value may be obtained from one or more sources, such as, for example, Broadcaster 130, Estimated Spend Server 125, Social Media Server 120, Search Server 115, or another party.

At block 515, the Spend Estimation Routine 500 may obtain the estimated cost to produce and distribute the Advertisement 397 associated with the Ad ID 305. Information used to arrive at this estimation may be obtained from, for example, Estimated Spend Server 125, Broadcaster 130, or another party. The information may provide a total figure or a figure in relation to a unit of time, an incidence of transmission of the Advertisement 397 (such as transmission in Program 398), or according to other parameters which may need to be normalized to arrive at a total cost. The information may include information from the Ad Metadata 340 records, such as the length of the Advertisement 397, the Broadcast Network 155 or other distribution media, the geographic area, the type or categorization of the Program 398 in which the Advertisement 397 appeared, the time, day, month, and year when the Advertisement 397 appeared. The information may include an actual or estimated placement cost, for placement of an advertisement in a program, including in Program 398 and in the distribution media.

At block 520, the Spend Estimation Routine 500 may normalize the data obtained at block 515 to determine the estimated cost to produce and distribute the Advertisement associated with Ad ID 305 through the then-current date. This figure may be saved in, for example, one or more Estimated Spend 320 records.

At block 525, the value of block 520 may be divided by the estimated program viewership of block 510 to determine a spend per viewer and/or may be divided by Airing Days 330 to determine a spend per airing day (or other unit of time) and/or to determine a spend per airing day per viewer. This may also be referred to herein as the “average spend per unit,” (wherein “unit” may be a day, viewer, or a viewer-day).

At block 530, the Spend Estimation Routine 500 may return to block 505 to iterate over the next Ad ID 305, if any.

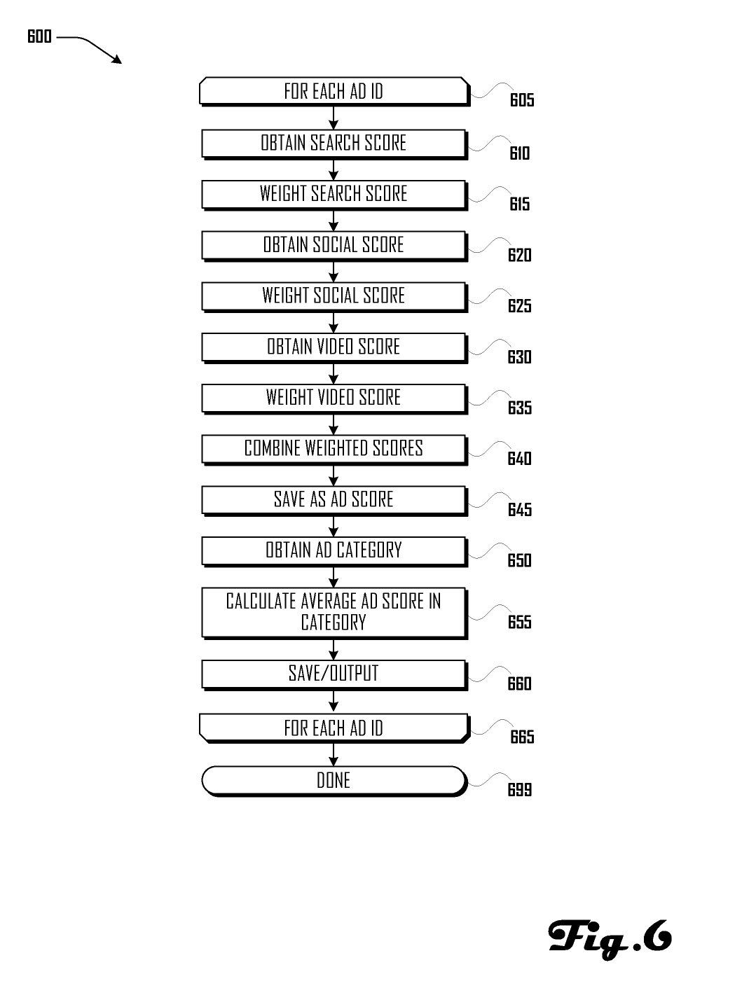

FIG. 6 illustrates an Ad Score Routine 600, in which a score for an advertisement, an Ad Score 395, is determined. Blocks 605 to 665 iterate for each Ad ID 305.

At block 610, a search score for the Ad ID 305 may be obtained. The search score quantizes, among other factors, the number of searches which relate to the Advertisement 397 associated with the Ad ID 305. An example of a search score is Search Score 355, calculated by Search Score Routine 700 and discussed further in relation to FIG. 7 or calculated by Score Estimation Routine 1000 and discussed further in relation to FIG. 10. At block 615, the search score may be weighted, such as by multiplying the search score by a weighting factor.

At block 620, a social score for the Ad ID 305 may be obtained. The social score quantizes, among other factors, the number of social tags (such as shares, mentions, and the like) or similar which relate to the Advertisement 397 and are associated with the Ad ID 305. An example of a social score is Social Score 360, calculated by Social Score Routine 800 and discussed further in relation to FIG. 8. At block 625, the social score may be weighted, such as by multiplying the social score by a weighting factor.

At block 630, a video score for the Ad ID 305 may be obtained. The video score quantizes, among other factors, the number of online views of the Advertisement 397 associated with the Ad ID 305. An example of a video score is Video Score 370, calculated by Video Score Routine 900 and discussed further in relation to FIG. 9. At block 635, the video score may be weighted, such as by multiplying the video score by a weighting factor.

The weighting factors for the search score, social score, and video score may each be a decimal which, together, add up to one. The weighting factor for the social score may be larger (or heavier) than the weighting factor for the video score, while the weighting factor for the search score may be lowest. Other weighting factors and approaches to weighting the score may be used.

At block 640, the weighted scores of blocks 615, 625, and 635 may be combined, such as by addition, and, at block 645, may be saved as Ad Score 395.

At block 650, a category associated with the Ad ID 305 may be obtained. The Category 390 may be assigned, for example, at block 440 of FIG. 4.

At block 655, the average, mean (or the like) Ad Score 395 for all Ad IDs 305 associated with the Category 390 of block 650 may be calculated. This calculation may be performed after the Ad Score 645 for a particular Ad ID 305 has been determined or this calculation may be performed periodically, in a batch, or may be performed when the average, mean (or the like) Ad Score 395 for all Ad IDs 305 associated with the Category is requested.

At block 660, the output of block 655 may be saved or output, such as to a website.

At block 665, the Ad Score Routine 600 may return to block 605 to iterate over the next Ad ID 305, if any.

FIG. 7 illustrates Search Score Routine 700, providing an example of how a search score for an Ad ID 305 may be determined. Blocks 705 to 745 iterate for all Ad IDs 305. Blocks 710 to 735 iterate for each Ad ID 305. Blocks 710 to 735 and 740 may be performed relatively infrequently, such as once per week or month. As an alternative to blocks 710 to 735 and 740 is discussed, below, in relation to Score Estimation Routine 1000, which may be performed more frequently.

At block 715, the number of searches in a unit of time (such as a day) may be obtained. The number of searches may comprise the number of search queries associated with the Ad ID 305, such as Search Query 345, and/or the number of clicks on search queries associated with the Ad ID 305, such as Search Clicks 335. These different types of searches may be weighted before being combined.

At block 720, the product of block 715 may be divided by the number of days (or the span of time) during which the Ad ID 305 was associated with any digital activity, such as with a Search Query 345, a Search Click 335, a Social Tag 350, or an Online Play 396.

At block 725, the product of block 720 may be divided by the amount spent to produce and/or distribute the Advertisement 397 or the average spend per unit, such as the Estimated Spend 320 value determined by Spend Estimation Routine 500 at block 525.

At block 730, the product(s) of block 725 may be saved as a Search Index 375 value associated with the Ad ID 305.

At block 735, Search Score Routine 700 may return to block 710 to iterate over the next Ad ID 305, if any.

At block 740, Search Index 375 values for all Ad IDs 305 may be ordered or ranked. The ordering may be by descending value. Each row in the ordered list may be assigned a sequentially incremented integer (such as by one), with the output being Search Index 375 rank, which essentially ranks the Search Index 375 values. The ranked Search Index 375 values may also be referred to herein as a “search rank.”

At block 745, Search Score Routine 700 may return to block 705 until all the Ad IDs 305 have been processed.

Blocks 750 to 775 may be performed for each Ad ID 305.

At block 755, Search Score Routine 700 may obtain the total number of Ad IDs 305 which are associated with a Search Index 375 value. This may be the maximum Search Index 375 rank. At block 760, Search Index 375 value associated with the then-current Ad ID 305 may be subtracted from the value of block 755. At block 765, the value of block 760 may be divided by the total number of Ad IDs 305 which are associated with a Search Index 375 value. At block 770, the value of block 765 may be saved as Search Score 355 associated with the then-current Ad ID 305.

At block 775, the Search Score Routine 700 may return to block 750 to iterate over the next Ad ID 305, if any.

At block 799, the Search Score Routine 700 may conclude.

FIG. 8 illustrates Social Score Routine 800, providing an example of how a social score for an Ad ID 305 may be determined. Blocks 805 to 845 iterate for all Ad IDs 305. Blocks 810 to 835 iterate for each Ad ID 305. Blocks 810 to 835 and 840 may be performed relatively infrequently, such as once per week or month. As an alternative to blocks 810 to 835 and 840 is discussed, below, in relation to Score Estimation Routine 1000, which may be performed more frequently.

At block 815, the number of social tags in a unit of time may be obtained. The number of social tags may comprise the number of likes, shares, mentions, comments, votes and the like which may be associated with the Ad ID 305. This number may be obtained from, for example, Social Tag 350, as may be determined by Network Monitor Routine 400.

At block 820, the product of block 815 may be divided by the number of days (or the span of time) during which the Ad ID 305 was associated with any digital activity, such as with a Search Query 345, a Search Click 335, a Social Tag 350, or an Online Play 396.

At block 825, the product of block 820 may be divided by the amount spent to produce and/or distribute the Advertisement 397 or the average spend per unit, such as the Estimated Spend 320 value determined by Spend Estimation Routine 500 at block 525.

At block 830, the product(s) of block 825 may be saved as a Social Index 380 value associated with the Ad ID 305.

At block 835, Social Score Routine 800 may return to block 810 to iterate over the next Ad ID 305, if any.

At block 840, Social Index 380 values for all Ad IDs 305 may be ordered or ranked. The ordering may be by descending value. Each row in the ordered list may be assigned a sequentially incremented integer (such as by one), with the output being Social Index 380 rank, which essentially ranks the Social Index 380 values. The ranked Social Index 380 values may also be referred to herein as a “social rank.”

At block 845, Social Score Routine 800 may return to block 805 until all the Ad IDs 305 have been processed.

Blocks 850 to 875 may be performed for each Ad ID 305.

At block 855, Social Score Routine 800 may obtain the total number of Ad IDs 305 which are associated with a Social Index 380 value. This may be the maximum Social Index 380 rank. At block 860, Social Index 380 value associated with the then-current Ad ID 305 may be subtracted from the value of block 855. At block 865, the value of block 860 may be divided by the total number of Ad IDs 305 which are associated with a Social Index 380 value. At block 870, the value of block 865 may be saved as Social Score 360 associated with the then-current Ad ID 305. At block 875, the Social Score Routine 800 may return to block 850 to iterate over the next Ad ID 305, if any.

At block 899, the Social Score Routine 800 may conclude.

FIG. 9 illustrates Video Score Routine 900, providing an example of how a video score for an Ad ID 305 may be determined. Blocks 905 to 945 iterate for all Ad IDs 305. Blocks 910 to 935 iterate for each Ad ID 305. Blocks 910 to 935 and 940 may be performed relatively infrequently, such as once per week or month. As an alternative to blocks 910 to 935 and 940 is discussed, below, in relation to Score Estimation Routine 1000, which may be performed more frequently.

At block 915, the number of online video plays associated with the Ad ID 305 may be obtained. This number may be obtained from, for example, Online Play 396, as may be determined by Network Monitor Routine 400.

At block 920, the product of block 915 may be divided by the number of days (or the span of time) during which the Ad ID 305 was associated with any digital activity, such as with a Search Query 345, a Search Click 335, a Social Tag 350, or an Online Play 396.

At block 925, the product of block 920 may be divided by the amount spent to produce and/or distribute the Advertisement 397 or the average spend per unit, such as the Estimated Spend 320 value determined by Spend Estimation Routine 500 at block 525.

At block 930, the product(s) of block 925 may be saved as a Video Index 385 value associated with the Ad ID 305.

At block 935, Video Score Routine 900 may return to block 910 to iterate over the next Ad ID 305, if any.

At block 940, Video Index 385 values for all Ad IDs 305 may be ordered or ranked. The ordering may be by descending value. Each row in the ordered list may be assigned a sequentially incremented integer (such as by one), with the output being Video Index 385 rank, which essentially ranks the Video Index 385 values. The ranked Video Index 385 values may also be referred to herein as a “video rank.”

At block 945, Video Score Routine 900 may return to block 905 until all the Ad IDs 305 have been processed.

Blocks 950 to 975 may be performed for each Ad ID 305.

At block 955, Video Score Routine 900 may obtain the total number of Ad IDs 305 which are associated with a Video Index 385 value. This may be the maximum Video Index 385 rank. At block 960, Video Index 385 value associated with the then-current Ad ID 305 may be subtracted from the value of block 955. At block 965, the value of block 960 may be divided by the total number of Ad IDs 305 which are associated with a Video Index 385 value. At block 970, the value of block 965 may be saved as Video Score 370 associated with the then-current Ad ID 305.

At block 975, the Video Score Routine 900 may return to block 950 to iterate over the next Ad ID 305, if any.

At block 999, the Video Score Routine 900 may conclude.

FIG. 10 illustrates Score Estimation Routine 1000, providing an example of how search, social, and video scores for an Ad ID 305 may be estimated.

Blocks 1005 through 1025 may be performed for new Ad IDs 305 and/or for existing Ad IDs 305 when it is not desired or necessary to perform the processes outlined in FIGS. 7-9.

At block 1010, blocks 710-735, 810-835, and 910-935 from FIGS. 7, 8, and 9, respectively, may be performed for the Ad ID 305. These blocks respectively produce a Search Index 375 value, a Social Index 380 value, and a Video Index 385 value.

At block 1015, the values of block 1010 may be cross-referenced to identify Search Score 355, Social Score 360, and Video Score 370 values previously obtained for all other Ad IDs 305 which are proximate to the values of block 1010; as used in this context, “proximate” may be understood as the value which is the same as, the next value above, the next value below, or the next value above or below the values of block 1010 within a specified range. These proximate values are then used at block 1015 to identify the Search Score 355, Social Score 360, and Video Score 370 which have been determined for other Ad IDs 305 which are proximate to the values obtained at block 1010.

At block 1020, the Search Score 355, Social Score 360, and Video Score 370 for other Ad IDs 305 which are proximate to the values obtained at block 1010 are assigned as estimated Search Score 355, Social Score 360, and Video Score 370 for the Ad ID 305 being processed.

At block 1099, the Score Estimation Routine 100 may conclude or return to iterate over the next Ad ID 305.

The above Detailed Description of embodiments is not intended to be exhaustive or to limit the disclosure to the precise form disclosed above. While specific embodiments of, and examples are described above for illustrative purposes, various equivalent modifications are possible within the scope of the system, as those skilled in the art will recognize. For example, while processes or blocks are presented in a given order, alternative embodiments may perform routines having operations, or employ systems having blocks, in a different order, and some processes or blocks may be deleted, moved, added, subdivided, combined, and/or modified. While processes or blocks are at times shown as being performed in series, these processes or blocks may instead be performed in parallel, or may be performed at different times. Further, any specific numbers noted herein are only examples; alternative implementations may employ differing values or ranges.

1. A method of determining a score for an advertisement in a set of advertisements performed in a computer comprising a memory, the method comprising:
preparing a search index value for each of the advertisements in the set of advertisements by dividing a number of searches associated with each advertisement by an amount of time during which each advertisement had any digital activity and dividing the result thereof by an estimated amount of spending on each advertisement divided by an amount of time during which each advertisement aired on television;
preparing a search rank for each of the advertisements in the set of advertisements by accessing in the memory the search index value for each advertisement in the set of advertisements, ordering the set of search index values, and assigning the search rank for each advertisement based on the location of the search index value for each advertisement in the set of ordered search index values;
preparing a search score for each of the advertisements in the set of advertisements by accessing in the memory a total number of advertisements with a search rank, subtracting from the total number of advertisements with a search rank, the search rank of the advertisement, and dividing the result by the total number of advertisements with a search rank in the set of advertisements;
preparing a social index value for each of the advertisements in the set of advertisements by dividing a number of social tags associated with each advertisement by the amount of time during which each advertisement had any digital activity and dividing the result thereof by the estimated amount of spending on each advertisement divided by the amount of time during which each advertisement aired on television;
preparing a social rank for each of the advertisements in the set of advertisements by accessing in the memory the social index value for each advertisement in the set of advertisements, ordering the set of social index values, and assigning the social rank for each advertisement based on the location of the social index value for each advertisement in the set of ordered social index values;
preparing a social score for each of the advertisements in the set of advertisements by accessing in the memory a total number of advertisements with a social rank, subtracting from the total number of advertisements with a social rank the social rank of the advertisement, and dividing the result by the total number of advertisements with a social rank in the set of advertisements;
preparing a video index value for each of the advertisements in the set of advertisements by dividing a number of online video views of the advertisement by the amount of time during which each advertisement had any digital activity and dividing the result thereof by the estimated amount of spending on each advertisement divided by the amount of time during which each advertisement aired on television;
preparing a video rank for each of the advertisements in the set of advertisements by accessing in the memory the video index value for each advertisement in the set of advertisements, ordering the set of video index values, and assigning the video rank for each advertisement based on the location of the video index value for each advertisement in the set of ordered video index values;
preparing a video score for each of the advertisements in the set of advertisements by accessing in the memory a total number of advertisements with a video rank, subtracting from the total number of advertisements with a video rank the video rank of the advertisement, and dividing the result by the total number of advertisements with a video rank in the set of advertisements;
weighting the search score, social score, and video score;
combining the weighted scores as an advertisement score; and
outputting the advertisement score.

2. A method of determining a score for an advertisement performed in a computer comprising a memory, the method comprising:
accessing in the memory a search score, a social score, and a video score for the advertisement;
weighting the search score, social score, and video score;
combining the weighted scores as an advertisement score; and
outputting the advertisement score.

3. The method of claim 2, further comprising accessing in the memory a category associated with the advertisement, an average advertisement score of all advertisements associated with the category, and outputting the average advertisement score of all advertisements associated with the category in conjunction with the advertisement score.

4. The method of claim 2, wherein the search score is determined by a method comprising:
accessing in memory a total number of advertisements with a search rank in a set of advertisements, subtracting from the total number of advertisements with a search rank the search rank of the advertisement, and dividing the result by the total number of advertisements with a search rank in the set of advertisements.

5. The method of claim 4, wherein the search rank is determined by a method comprising:
accessing in memory a set of search index values for each advertisement in the set of advertisements, ordering the values in the set of search index values, and assigning the search rank based on the location of the search index value of the advertisement in the set of ordered search index values.

6. The method of claim 5, wherein the search index value is determined by a method comprising:
dividing a number of searches associated with the advertisement by an amount of time during which the advertisement had any digital activity and dividing the result thereof by an estimated amount of spending on the advertisement divided by the amount of time during which the advertisement aired on television.

7. The method of claim 6, wherein any digital activity comprises at least one of an online video play of the advertisement, a search query associated with the advertisement, and a social tag associated with the advertisement.

8. The method of claim 2, wherein the social score is determined by a method comprising:
accessing in memory a total number of advertisements with a social rank in a set of advertisements, subtracting from the total number of advertisements with a social rank the social rank of the advertisement, and dividing the result by the total number of advertisements with a social rank in the set of advertisements.

9. The method of claim 8, wherein the social rank is determined by a method comprising:
accessing in memory a set of social index values for each advertisement in the set of advertisements, ordering the values in the set of social index values, and assigning the social rank based on the location of the social index value of the advertisement in the set of ordered social index values.

10. The method of claim 9, wherein the social index value is determined by a method comprising:
dividing a number of social tags associated with the advertisement by an amount of time during which the advertisement had any digital activity and dividing the result thereof by an estimated amount of spending on the advertisement divided by the amount of time during which the advertisement aired on television.

11. The method of claim 10, wherein any digital activity comprises at least one of an online video play of the advertisement, a search query associated with the advertisement, and a social tag associated with the advertisement.

12. The method of claim 2, wherein the video score is determined by a method comprising:
accessing in memory a total number of advertisements with a video rank in a set of advertisements, subtracting from the total number of advertisements with a video rank the video rank of the advertisement, and dividing the result by the total number of advertisements with a video rank in the set of advertisements.

13. The method of claim 12, wherein the video rank is determined by a method comprising:
accessing in memory a set of video index values for each advertisement in the set of advertisements, ordering the values in the set of video index values, and assigning the video rank based on the location of the video index value for the advertisement in the set of ordered video index values.

14. The method of claim 13, wherein the video index value is determined by a method comprising:
dividing a number of online video views of the advertisement by an amount of time during which the advertisement had any digital activity and dividing the result thereof by an estimated amount of spending on the advertisement divided by the amount of time during which the advertisement aired on television.

15. The method of claim 14, wherein any digital activity comprises at least one of an online video play of the advertisement, a search query associated with the advertisement, and a social tag associated with the advertisement.

16. The method of claim 2, further comprising determining an amount of spending on the advertisement by a method comprising:
accessing in the memory a cost to produce and/or distribute the advertisement;
accessing in the memory a unit;
calculating the costs divided by the unit.

17. The method of claim 16, wherein the unit comprises at least one of a unit of time and a number of viewers.

18. The method of claim 16, wherein the cost to produce and/or distribute the advertisement is based on at least one of a network on which the advertisement appeared, a program on which the advertisement appeared, a time of day when the advertisement was made available, a day of the week when the advertisement was made available, a length of the advertisement, and an insertion cost to place the advertisement in a program.

19. The method of claim 2, wherein the social score, video score, and search score are weighted by different factors and where the weight factor for the social score is heaviest, the weight factor for the search score is in the lowest, and the weight factor for the video score is between the weight factor for the social score and the weight factor for the search score.

20. The method of claim 2, further comprising:
accessing advertisements and assigning an advertisement identifier to each of the accessed advertisements;
obtaining advertisement metadata for each of the accessed advertisements and making the advertisement metadata available to search engines;
obtaining search queries and clicks on the results of search queries, which search queries are associated with the advertisement metadata; and
obtaining social media tags in social media content from social media servers, which social media tags are associated with the advertisement metadata.

21. The method of claim 20, further comprising preparing a digital fingerprint of the accessed advertisements and wherein the advertisement identifier is an existing advertisement identifier if the digital fingerprint has been detected previously or is a new advertisement identifier if the digital fingerprint has not been detected previously.

22. A computing apparatus for determining a score for an advertisement in a set of advertisements, the apparatus comprising a processor and a memory storing instructions that, when executed by the processor, configure the apparatus to:
access in the memory a search score, a social score, and a video score for the advertisement;
weight the search score, social score, and video score;
combine the weighted scores as an advertisement score; and
output the advertisement score.

23. A non-transient computer-readable storage medium having stored thereon instructions that, when executed by a processor, configure the processor to:
access in the memory a search score, a social score, and a video score for an advertisement in a set of advertisements;
weight the search score, social score, and video score for the advertisement;
combine the weighted scores as an advertisement score for the advertisement; and
output the advertisement score for the advertisement.
